(19) United States
(12) Patent Application Publication
(10) Pub. No.: US 2014/0297320 A1
(43) Pub. Date: Oct. 2, 2014

(54) SYSTEMS AND METHODS FOR OPERATING A PERSONAL HEALTHCARE MANAGEMENT PORTAL

(71) Applicant: MCKESSON SPECIALTY CARE DISTRIBUTION CORPORATION, San Francisco, CA (US)

(72) Inventors: Asif H. Jiwani, Sugar Land, TX (US); Alan Chad Stickler, The Woodlands, TX (US); Asif Ahmad, The Woodlands, TX (US)

(73) Assignee: MCKESSON SPECIALTY CARE DISTRIBUTION CORPORATION, San Francisco, CA (US)

(21) Appl. No.: 13/853,590

(22) Filed: Mar. 29, 2013

(51) Int. Cl. G06F 19/00

(52) U.S. Cl. CPC G06F 19/322
USPC 705/3

(57) ABSTRACT

Systems and methods are provided for the operation of a personal healthcare management portal operable to provide multiple users secure access to a patient's healthcare information. A selection of a patient healthcare management portal associated with a patient may be received by an application tier. The application tier may receive authentication information associated with the selection of the patient healthcare management portal associated with the patient. The application tier may determine if the authentication information is associated with a users valid login credentials. The application tier may receive a request to access patient information, wherein the patient information includes at least one of records, forms, or services associated with the patient. The application tier may also retrieve the requested patient information. The application tier may communicate the requested information to a client device from which the selection originated.

### TECHNICAL FIELD

Aspects of the disclosure relate generally to accessing a personal healthcare management portal, and more particularly, to systems and method for the operation of a personal healthcare management portal to provide multiple users secure access to a patient's healthcare information.

### BACKGROUND

Patient portals have become a near requirement for any certified Electronic Medical Record (EMR) system. Generally, today's patient portals provide only a patient access to their EMR. An EMR typically contains details concerning a patient's medical history, current medical condition, and planned future treatments. It is common in today's medical community for a primary care provider to refer patients to specialty providers based on the diagnosis of the patient. For example, this may result in a referral to a cardiologist for a heart condition, an orthopedic surgeon for a broken bone, or an oncologist for a cancer diagnosis.

In many cases the primary care provider may need to access information regarding a patient's care in a specialty setting so that the primary care provider can properly treat the patient. Information pertaining to a patient's care in a specialty setting may be accessible to a patient via a patient portal. The primary care provider however, may not have access to the patient portal and may have to spend extended periods of time and resources compiling that same patient information accessible via the patient portal. With the number of physician referrals within the medical community constantly on the rise, communication within the medical community is imperative to maintain the overall care of the patient.

Furthermore, patient caregivers may also need to have access to information regarding a patient's care. For example, family and/or friends may need access to patient medical information such as medication information, appointment schedules, and the like. However, with ever increasing privacy laws secondary parties are increasingly limited to individually identifiable health information.

Accordingly, improved systems and methods for providing accurate and timely access to a patient's healthcare information is desirable.

### SUMMARY

Exemplary embodiments disclosed herein may include systems and methods for the operation of a personal healthcare management portal to provide multiple users secure access to a patient's healthcare information. In one exemplary embodiment, a method for accessing patient information as part of a secure patient portal associated with an application tier can include receiving, at the application tier, a selection of a patient healthcare management portal associated with a patient. The selection may include authentication information processed to establish secure access to patient information via the patient healthcare management portal. The application tier may receive authentication information associated with the selection of the patient healthcare management portal associated with the patient. The application tier may determine if the authentication information is associated with a user's valid login credentials. The application tier may receive a request to access patient information, wherein the patient information includes at least one of records, forms, or services associated with the patient. The application tier may also retrieve the requested patient information. The application tier may communicate the requested information to the client device for presentation, if appropriate.

In accordance with another exemplary embodiment, a system for the operation of a personal healthcare management portal operable to provide multiple users designated access rights to establish secure access to a patient's healthcare information may be provided. The system may include at least one memory operable to store computer-executable instructions. The system may also include at least one processor configured to access the at least one memory and execute the computer-executable instructions. The processor may be configured to select a patient healthcare management portal associated with a patient associated with a client device. The selection may include authentication information processed to establish secure access to patient information via the patient healthcare management portal. The processor may be further configured to determine if the authentication information is associated with a users valid login credentials. The processor may be further configured to receive a request to access patient information, wherein the patient information includes at least one of records, forms, or services associated with the patient. The processor may be further configured to communicate the requested information to the client device for presentation, if appropriate.

### BRIEF DESCRIPTION OF THE DRAWINGS

Reference will now be made to the accompanying drawings, which are not necessarily drawn to scale, and wherein:

FIG. 1 illustrates an example overview of a system that facilitates the operation of a personal healthcare management portal, according to one exemplary embodiment.

FIG. 2 illustrates a flow chart of an example method for accessing a personal healthcare management portal, according to one exemplary embodiment.

FIG. 3 illustrates a flow chart of an example method for retrieving real time data associated with a patient's medical records and presenting the data to a user, according to one exemplary embodiment.

FIG. 4 illustrates a flow chart of an example method for delegating, to a secondary user, access and/or authority to a primary user's healthcare information and/or records, according to one exemplary embodiment.

FIG. 5 illustrates a flow chart of an example method for providing a proxy user access to a primary user's healthcare information and/or records, according to one exemplary embodiment.

FIG. 6 illustrates a flow chart of an example method for providing a secondary user access to a primary user's healthcare information and/or records, according to one exemplary embodiment.

FIG. 7 illustrates a flow chart of an example method for delivering a notification to a secondary user associated with a personal healthcare management portal, according to one exemplary embodiment.

FIG. 8 illustrates a flow chart of an example method for providing a referring physician access to a primary user's healthcare information and/or records, according to one exemplary embodiment

FIGS. 9 and 10 depict example graphical user interfaces that may be displayed in accordance with various embodiments of the disclosure.

### DETAILED DESCRIPTION OF EXEMPLARY EMBODIMENTS

Exemplary embodiments described herein include systems and methods for the operation of a personal healthcare management portal to provide multiple people secure access to a patient's healthcare information. The operation of the personal healthcare management portal may be part of a secure healthcare system to access timely and accurate patient healthcare information (i.e., patient records, patient forms, or services associated with the patient), in real-time or near real-time.

This brief introduction, is provided for the reader's convenience and is not intended to limit the scope of the claims, nor the proceeding sections. Furthermore, the techniques described above and below may be implemented in a number of ways and in a number of contexts. Several example implementations and contexts are provided with reference to the following figures, as described below in more detail. However, the following implementations and contexts are but a few of many.

Exemplary embodiments will now be described more fully hereinafter with reference to the accompanying drawings, in which exemplary embodiments are shown. The concepts disclosed herein may, however, be embodied in many different forms and should not be construed as limited to the exemplary embodiments set forth herein; rather, these embodiments are provided so that this disclosure will be thorough and complete, and will fully convey the scope of the concepts to those skilled in the art. Like numbers refer to like, but not necessarily the same or identical, elements throughout.

System Overview

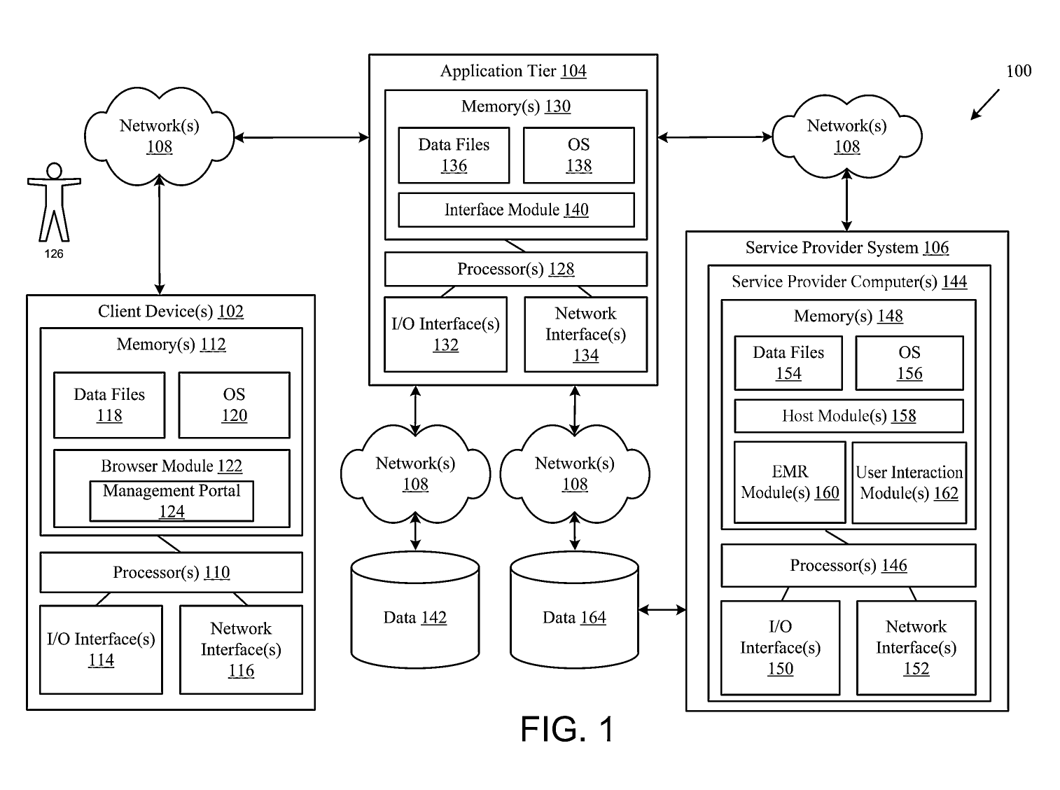

FIG. 1 illustrates an example system 100 for facilitating, among other things, the operation of a personal healthcare management portal, associated application tier device, and integrated service provider systems. As shown in FIG. 1, the system 100 may include one or more client devices 102, application tier 104, and one or more service provider systems 106. As desired, each of the client devices 102, application tier 104, and service provider systems 106 may include one or more processing devices that may be configured for accessing and reading associated computer-readable media having stored thereon data and/or computer-executable instructions for implementing various embodiments of the disclosure.

Generally, network devices and systems, including one or more of the client devices 102, application tier 104, and service provider systems 106, may include or otherwise be associated with suitable hardware and/or software for transmitting and receiving data and/or computer-executable instructions over one or more communication links or networks. These network devices and systems may also include any number of processors for processing data and executing computer-executable instructions, as well as other internal and peripheral components currently known in the art or which may be developed in the future. Further, these network devices and systems may include or be in communication with any number of suitable memory devices operable to store data and/or computer-executable instructions. By executing computer-executable instructions, each of the network devices may form a special-purpose computer or particular machine. As used herein, the term “computer-readable medium” describes any medium for storing computer-executable instructions.

As shown in FIG. 1, the client devices 102, application tier 104, and service provider systems 106 may be in communication with each other via one or more networks, such as network 108, which may include one or more independent and/or shared private and/or public networks including the Internet or a publicly switched telephone network. In other embodiments, one or more components of the system 100 may communicate via direct connections and/or communication links. Each of these components—client devices 102, application tier 104, service provider systems 106, and network 108—will now be discussed in further detail. Although the components are generally discussed as singular components, as may be implemented in various embodiments, each component may include any number of suitable computers and/or other components.

With continued reference to FIG. 1, any number of client devices 102 may be associated with any number of users, for example, any number of patients, referring physicians, patient caregivers, patient relatives or interested parties, etc. A client device 102 may be any suitable processor-driven device that facilitates the processing of requests made by or on behalf of patients or other users (e.g., requests to view healthcare records, view test results, view an appointment calendar, submit a prescription, indicate a need for transportation to an appointment, etc.). Requests for healthcare information may be communicated by the client device 102 to the application tier 104 for processing. The application tier 104 may communicate the processed healthcare information request to a service provider system 106 for retrieval of the healthcare information requested by the client device 102. For example, the client device 102 may be a computing device that includes any number of server computers, mainframe computers, networked computers, desktop computers, personal computers, mobile devices, smartphones, digital assistants, personal digital assistants, tablet devices, Internet appliances, application-specific integrated circuits, microcontrollers, minicomputers, and/or any other processor-based devices. The client device 102 having computer-executable instructions stored thereon may form a special-purpose computer or other particular machine that is operable to facilitate the processing of requests for healthcare information made by or on behalf of patients or other users and the communication of requested healthcare information to the application tier 104 and/or the service provider system 106. Additionally, in certain embodiments, the operations and/or control of the client device 102 may be distributed among several processing components.

In addition to including one or more processors 110, the client device 102 may further include one or more memory devices (or memory) 112, one or more input/output (“I/O”) interfaces 114, and one or more network interfaces 116. The memory devices 112 may be any suitable memory devices, for example, caches, read-only memory devices, random access memory devices, magnetic storage devices, removable storage devices, etc. The memory devices 112 may store data, executable instructions, and/or various program modules utilized by the client device 102, for example, data files 118, an operating system (“OS”) 120, a browser module 122, and/or a management portal 124. The data files 118 may include any suitable data that facilitates the receipt and/or processing by the client device 102 of requests made by or on behalf of patients or other users, and/or the generation and/or processing of information requests and response thereto (e.g., requests to view healthcare records, view test results, view an appointment calendar, submit a prescription, indicate a need for transportation to an appointment, etc.) that are communicated to and received from the application tier device 104.

The OS 120 may be a suitable software module that controls the general operation of the client device 102. The OS 120 may also facilitate the execution of other software modules by the one or more processors 110, for example, the browser module 122 and/or the management portal 124. The OS 120 may be any operating system known in the art or which may be developed in the future including, but not limited to, Microsoft Windows®, Apple OSX™, Linux, Unix, or a mainframe operating system.

The management portal 124 may be an Internet browser or other software applications, including a dedicated program, for interacting with the application tier 104. For example, a user 126, such as a patient, patient representative or a referring physician, may utilize the management portal 124 in preparing and providing an information request to the application tier device 104 for retrieving requested healthcare information from the service provider system 106. Furthermore, the client device 102 may utilize the management portal 124 to retrieve or otherwise receive data, messages, or responses from the application tier 104 and/or other components of the system 100.

In operation, the client device 102 may receive information associated with a request (e.g., a request to view healthcare records, view test results, view an appointment calendar, submit a prescription, indicate a need for transportation to an appointment, etc.). As a non-limiting example, the management portal 124 on client device 102 may receive a request from an oncology patient to view a medical record. The client device 102 may engage the application tier 104 to retrieve the requested information from the service provider system 106. The client device 102 may then receive one or more responses to the information request, such as a copy of the requested medical record.

The one or more I/O interfaces 114 may facilitate communication between the client device 102 and one or more input/output devices, for example, one or more user interface devices, such as a display, keypad, control panel, touch screen display, remote control, microphone, etc., that facilitate user interaction with the client device 102. For example, the one or more I/O interfaces 114 may facilitate entry of requests for information (e.g., such as a request for an appointment schedule, etc.) by a patient or referring physician. The one or more network interfaces 116 may facilitate connection of the client device 102 to one or more suitable networks, for example, the network 108 illustrated in FIG. 1. In this regard, the client device 102 may receive and/or communicate information to other network components of the system 100, such as the application tier 104.

With continued reference to FIG. 1, an application tier 104 may include, but is not limited to, any suitable processor-driven device that is configured for receiving, processing, and fulfilling information requests from client device 102 and/or service provider systems 106 relating to requests to view healthcare records, view test results, view an appointment calendar, submit a prescription, indicate a need for transportation to an appointment, and/or other activities associated with a patient. In certain embodiments, the application tier 104 communicates information requests communicated from the client device 102 and information retrieved from the service provider system 106, which may be associated with a hospital network EMR system, a physician's office, a pharmacy, an insurer, or some other information source. In certain embodiments, the application tier 104 may include a suitable host server, host module, or other software that facilitates the fulfillment of information requests. Any number of client devices 102 and/or service provider systems 106 may be in communication with the application tier 104, as desired in various embodiments.

The application tier 104 may include any number of special-purpose computers or other particular machines, application-specific integrated circuits, microcontrollers, personal computers, minicomputers, mainframe computers, servers, networked computers, and/or other processor-driven devices. In certain embodiments, the operations of the application tier 104 may be controlled by computer-executed or computer-implemented instructions that are executed by one or more processors associated with the application tier 104 to form a special-purpose computer or other particular machine that is operable to facilitate the receipt, routing, and/or processing of healthcare requests or healthcare transactions. The one or more processors that control the operations of the application tier 104 may be incorporated into the application tier 104 and/or may be in communication with the application tier 104 via one or more suitable networks. In certain embodiments, the operation and/or control of the application tier 104 may be distributed among several processing components.

Similar to the client device 102, the application tier 104 may include one or more processors 128, one or more memory devices 130, one or more I/O interfaces 132, and one or more network interfaces 134. The one or more memory devices 130 may be any suitable memory device, for example, caches, read-only memory devices, etc. The one or more memory devices 130 may store data, executable instructions, and/or various program modules utilized by the application tier 104, for example, data files 136, an OS 138, and/or an interface module 140. The OS 138 may be any operating system known in the art or which may be developed in the future including, but not limited to, Microsoft Windows®, Apple OSX™, Linux, Unix, or a mainframe operating system. The OS 138 may be a suitable software module that controls the general operation of the application tier 104 and/or that facilitates the execution of other software modules.

According to an example embodiment, the data files 136 may store user access credential records (e.g., user name or other user identification and password or other security check, etc.) associated with the user 128 requesting information via a client device 102 and/or various service provider systems 106. The data files 136 may also store any number of suitable routing tables that facilitate determining the destination of communications received from a client device 102 or a service provider system 106. Additionally, in one or more example embodiments of the disclosure, the application tier device 104 may be in communication with one or more databases and/or data storage devices 142.

The interface module 140 may include computer-executable instructions for facilitating the requests from a personal healthcare management portal for information recorded and/or stored in service provider systems 106 as described herein. As an example, interface module 140 may receive and communicate requests for healthcare information associated with a patient. In one non-limiting example, a healthcare request may be communicated by the communication device 102 using the management portal 124 to the interface module 140 over the network 108. Alternatively, the interface module 140 may also be implemented as computer-implemented instructions of a memory of a separate computing entity or processor-based system, according to an example embodiment.

As a non-limiting example, a user 126 may be a referring physician. The referring physician may communicate a request associated with a patient using the management portal 124. The request may include a request for specific laboratory results associated with tests performed on the patient by a medical specialist consulted by the referring physician. The request may be communicated by the client device 102 to the interface module 140 of the application tier 104 via the network 108. The interface module 140 may process the request and access one or more data sources to locate the requested information, for example, without limitation, one or more of a proxy database or data warehouse, a medical management system such as an EMR system, or any other data source to retrieve the requested information. After retrieving the information requested, the interface module 140 may process the information retrieved to determine whether the client device is capable of presenting the information to the user in the current format. For example, the information may be displayed on an output device such as a display screen, output on a handheld device, printed, etc. Depending on the client device 102 and the user type, the display type may be a default setting or selected by the user. Continuing with the example, the interface module 140 may transform the information to the correct output format and communicate the information to the client device 102 for presentation to the user 126.

With continued reference to the application tier 104, the one or more I/O interfaces 132 may facilitate communication between the application tier 104 and one or more input/output devices, for example, one or more user interface devices, such as a display, keypad, control panel, touch screen display, remote control, microphone, etc., that facilitate user interaction with the application tier 104. The one or more network interfaces 134 may facilitate connection of the application tier 104 to one or more suitable networks, for example, the network 108 illustrated in FIG. 1. In this regard, the application tier 104 may communicate with other components of the system 100.

The application tier 104 may include additional program modules for performing other processing methods described herein. Those of ordinary skill in the art will appreciate that the application tier 104 may include alternate and/or additional components, hardware, or software without departing from the scope of the disclosure.

With continued reference to FIG. 1, any number of service provider systems 106 may be associated with any number of service provider computers 144. Each service provider computer 144 may be any suitable processor-driven device that facilitates receiving, processing, storing, and/or fulfilling healthcare transaction requests including, without limitation, requests for healthcare information, such as test results, general treatment information, appointment schedules, etc. For example, a service provider computer 144 may be a processor-driven device associated with a hospital network, a physician's office, a pharmacy, an insurer, etc. As desired, the service provider computer 144 may include any number of special-purpose computers or other particular machines, application-specific integrated circuits, microcontrollers, personal computers, minicomputers, mainframe computers, servers, and the like. In certain embodiments, the operations of the service provider computer 144 may be controlled by computer-executed or computer-implemented instructions that are executed by one or more processors associated with the service provider computer 144 to form a special-purpose computer or other particular machine that is operable to facilitate receiving, processing, storing, and/or fulfilling healthcare transaction request for information such as, without limitation, test results, general treatment information, appointment schedules, etc. The one or more processors that control the operations of a service provider computer 144 may be incorporated into the service provider computer 144 and/or may be in communication with the service provider computer 144 via one or more suitable networks. In certain embodiments, the operation and/or control of the service provider computer 144 may be distributed among several processing components.

Similar to other components of the system 100, each service provider system 106 may include one or more processors 146, one or more memory devices 148, one or more I/O interfaces 150, and one or more network interfaces 152. The one or more memory devices 148 may be any suitable memory devices, for example, caches, read-only memory devices, random access memory devices, magnetic storage devices, removable memory devices, etc. The one or more memory devices 148 may store data, executable instructions, and/or various program modules utilized by the service provider computers 144, for example, data files 154, an OS 156, a host module 158, an electronic medical records (EMR) module 160, and a user interaction module 162. The data files 154 may include any suitable information that is utilized by the service provider computer 144 for receiving, processing, storing, and/or fulfilling healthcare transactions request for information, such as test results, general treatment information, appointment schedules, etc. Additionally, in one or more example embodiments of the disclosure, the service provider computer 144 may be in communication with one or more databases, data warehouses, and/or a data storage device 164.

The OS 156 may be a suitable software module that controls the general operation of the service provider computer 144. The OS 156 may also facilitate the execution of other software modules by the one or more processors 146. The OS 156 may be any operating system known in the art or which may be developed in the future including, but not limited to, Microsoft Windows®, Apple OSX™, Linux, Unix, or a mainframe operating system.

The one or more I/O interfaces 150 may facilitate communication between the service provider computer 144 and one or more input/output devices, for example, one or more user interface devices, such as a display, keypad, control panel, touch screen display, remote control, microphone, etc., that facilitate user interaction with the service provider computers 144. The one or more network interfaces 152 may facilitate connection of the service provider computer 144 to one or more suitable networks, for example, the network 108 illustrated in FIG. 1. In this regard, the service provider computer 144 may receive information requests and/or other communications from the application tier 104 and the service provider computer 144 may communicate information associated with the request to the application device 104.

The network 108 may include any telecommunication and/or data network, whether public, private, or a combination thereof, including a local area network, a wide area network, an intranet, the Internet, intermediate handheld data transfer devices, and/or any combination thereof and may be wired and/or wireless, or any combination thereof. The network 108 may also allow for real time, offline, and/or batch transactions to be transmitted between or among the client device 102, the application tier 104, and the service provider system 106. Various methodologies as described herein may be practiced in the context of distributed computing environments. Although the application tier 104 is shown for simplicity as being in communication with the client device 102 or the service provider system 106 via one intervening network 108, it is to be understood that any other network configurations are possible. For example, the intervening network 108 may include a plurality of networks, each with devices such as gateways and routers for providing connectivity between or among the components of the system 100. Instead of or in addition to the network 108, dedicated communication links may be used to connect various devices in accordance with an example embodiment. For example, the application tier 104 may form the basis of a network 108 that interconnects the client device 102 and the service provider system 106.

Those of ordinary skill in the art will appreciate that the system 100 shown in and described with respect to FIG. 1 is provided by way of example only. Numerous other operating environments, system architectures, and device and network configurations are possible. Other system embodiments can include fewer or greater numbers of components and may incorporate some or all of the functionality described with respect to the system components shown in FIG. 1. For example, in an exemplary embodiment, the application tier 104 (or other computer) may be implemented as a specialized processing machine that includes hardware and/or software for performing the methods described herein. In addition, at least a portion of the processor 128 and/or the processing capabilities of the application tier 104 and/or the interface module 140, may be implemented as part of a client device 102. Accordingly, embodiments of the disclosure should not be construed as being limited to any particular operating environment, system architecture, or device or network configuration.

Operational Overview

Certain portions of the exemplary methods below will be described with reference to accessing data through a secure service giving real time access to clinical data for a specific patient; however, this is only for purposes of example as other means may be utilized to establish a secure service to access patient information and could be substituted for the secure system described herein. Each form of accessing clinical data for a specific patient should each individually be read as being used in the methods described below.

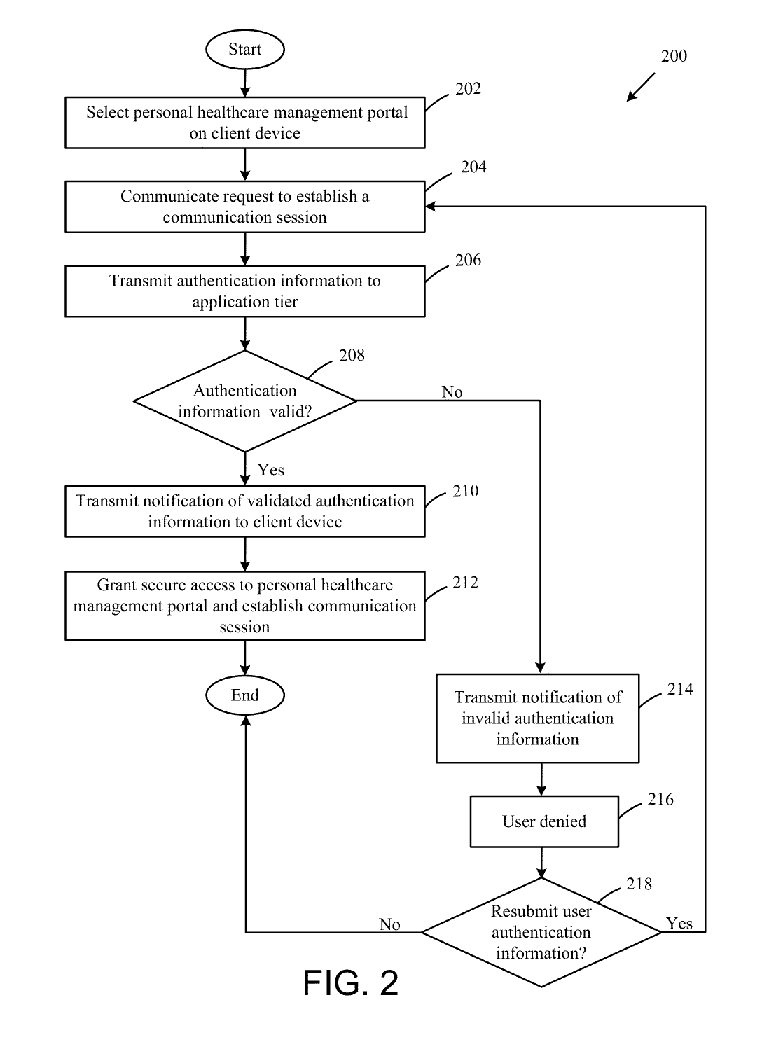

FIG. 2 illustrates a flow chart of an example method 200 for accessing a personal healthcare management portal, according to one exemplary embodiment. Referring now to FIGS. 1 and 2, the exemplary method 200 begins at block 202, where a personal healthcare management portal may be selected from a client device, such as management portal 124 of client device 102. In one non-limiting example, the personal healthcare management portal may provide a user secure access to a patient's medical records, as well as offer one or more services such as, without limitation, an ability for a user to manage appointments, submission of patient forms, access to associated medical information (e.g., medical research, medical studies, etc.), and/or request medication refills, providing the user a consolidated view of real time data associated with a current state of a patient's treatment.

In one non-limiting example, the user of the management portal 124 may be the patient themselves, referred to herein as a primary user. The primary user may include, without limitation, a patient or a primary care physician (referred to herein as the referring physician). The primary user may establish access parameters associated with a primary user account. The access parameters may include, without limitation, primary user settings such as language preference, primary user device preferences (e.g., client device 102), etc. The access parameters may also include data associated with one or more secondary users. In one non-limiting example, secondary users may include a caregiver, a supporting caregiver, a proxy, an attorney-in-fact, etc. The data associated with the secondary users may include, without limitation, a secondary user's name, a secondary user's profession, a secondary user's contact information (e.g., phone number, address, email, etc.), etc. The access parameters may permit the primary user to provide notifications, alarms, warnings, etc. associated with information accessed by the management portal 124 to a secondary user.

In certain embodiments, the primary user may grant various levels of access rights to secondary users. The access rights may permit the secondary user to access the primary user's medical records as well as other associated patient information. The access rights may grant, full access to a secondary user, minimal access to a secondary user, or any level of access in between. For example, a primary user may grant a proxy full access rights to the patient's medical records such that the proxy has access that is the same as or similar to the primary user. Furthermore, in some exemplary embodiments, the user (whether primary or secondary) may be granted access to more than ones patient's records. For example, a proxy may be granted access to multiple patient's personal healthcare management portals such that the proxy may access medical information associated with each of the patients.

At block 204, a request to establish a communication session with a client device may be received by an application tier, such as application tier 104. In one non-limiting example, the request may include a request to authenticate a user of the client device 102 prior to establishing the communication session. For example, a user may be prompted to input login credentials associated with the management portal 124. For example, upon selection of the management portal 124, discussed at block 202, a user may be prompted to enter one or more login credentials and/or other authentication information (e.g., a username/password, digital certificates, encryption keys, etc.).

At block 206, authentication information may be transmitted to an interface module of an application tier for evaluation, such as interface module 140 of application tier 104. In one example, where the client device 102 is a part of the application tier 104 or otherwise associated with the application tier 104, the transmission may be communicated via an internal connection or an intra-network connection. In another non-limiting example, where the client device 102 is a processor-based system distinct from the application tier 104, the transmission may be communicated via an external connection, for example, the network 108.

At block 208, the application tier 104 determines whether the authentication information is valid. In one non-limiting example, the interface module 140 of application tier 104 may determine whether the authentication information is valid by comparing the authentication information to one or more corresponding user records stored in the database 142. If, at block 208, the application tier 104 determines that the authentication information matches user records existing in a user file, then the YES branch is followed and processing may proceed to block 210. However, if at block 208, the application tier 104 determines that the authentication information does not match user records existing in a user file, then the NO branch is followed and processing may proceed to block 214.

At block 210, notification of validated user authentication information may be transmitted from the application tier 104 to the client device 102. In one example, where the client device 102 is a part of the application tier 104 or otherwise associated with the application tier 104, the transmission may be communicated via an internal connection or an intra-network connection. In another non-limiting example, where the client device 102 is a processor-based system distinct from the application tier 104, the transmission may be communicated via an external connection, for example, the network 108.

At block 212, a user may be granted secure access to a personal healthcare management portal and a communication session may be established. In certain embodiments, the communication session may be a web-based communications session. As another example, a communication session may be established via a dedicated network, such as a dedicated healthcare network. The method 200 may end following block 212.

At block 214, notification of invalid user authentication information may be transmitted from the application tier 104 to the client device 102. In one example, where the client device 102 is a part of the application tier 104 or otherwise associated with the application tier 104, the transmission may be communicated via an internal connection or an intra-network connection. In another non-limiting example, where the client device 102 is a processor-based system distinct from the application tier 104, the transmission may be communicated via an external connection, for example, the network 108.

At block 216, a user may be denied secure access to a personal healthcare management portal, such as management portal 116. At block 218, the interface module may determine whether a user has attempted to resubmit user authentication information. If at block 218, the interface module determines that a user has resubmitted authentication information, the YES branch is followed and processing may proceed to block 204. If however, at block 218, the user fails to resubmit authentication information, the NO branch is followed and the method may end.

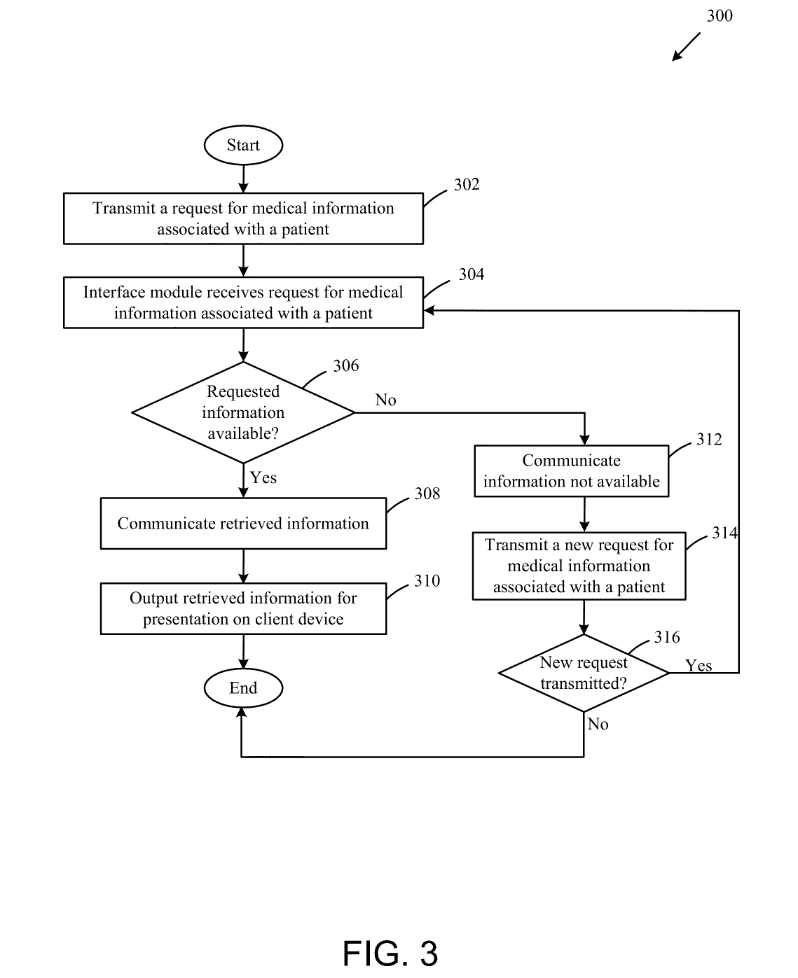

FIG. 3 illustrates a flow chart of an example method 300 for retrieving, from the service provider system 106, real time data associated with a patient's medical records and presenting the data to a user, according to one exemplary embodiment. As described herein at least with respect to FIG. 2, a user may be granted secure access to a personal healthcare management portal and a communication session may be established with an application tier 104. For example, without limitation, the communication session established at block 212 may enable the client device 102 to establish a secure connection with interface module 140.

Referring now to FIGS. 1 and 3, the exemplary method 300 begins at block 302, where a request for medical information associated with a patient may be sent to the application tier 140. In one non-limiting example, the request may be communicated from a management portal 140 of the client device 102 to the interface module 140 of the application tier 104. In certain example embodiments, where the application tier 104 is a part of the client device 102 or otherwise affiliated with a service provider system 106, the request may be communicated via an internal connection or an intra-network connection. In yet other exemplary embodiments, where the application tier 104 is a processor-based system distinct from the client device 102, the request may be communicated via an external connection, for example, via a network 108.

At block 304, interface module 140 may receive the request for medical information associated with a patient from the client device 102. The interface module 140 may subsequently query the service provider system 102 for the information requested by the client device 102. In one non-limiting example, the query may be directed to one or more sources associated with the service provider system 106. For example, without limitation, the interface module 140 may establish communication with at least an EMR module 160 and/or a user interaction module 162 of the service provider computer 144 and/or directly access a database 164. The query may include, without limitation, a request communicated to the EMR module 162 and/or the user interaction module 162 for information associated with one or more patient medications, appointment times, lab results, x-ray results, treatment results, clinical studies associated with a medication and/or treatment regimen, and the like.

A wide variety of suitable methods and/or techniques may be utilized to obtain the requested information. For example, the EMR module 160 of the service provider computer 144 may identify one or more parameters associated with the request. The EMR module 160 may access EMR data from one or more memory devices and/or databases (e.g., internal databases, external databases, etc.) associated with the service provider system 106. EMR data may include a wide variety of information, such as patient identification information, information associated with medical and/or medication history of a patient, information associated with a current medical status of a patient, and/or information associated with future or planned treatments and/or medication therapy. In certain embodiments, an amount of EMR information that is obtained may be limited by operating parameters associated with the service provider system 106, such as backup, caching, and/or data redundancy parameters. For example, available system resources associated with the clustering of backup data may be taken into consideration.

Furthermore, in one non-limiting example, the user interaction module 162 of the service provider computer 144 may also identify one or more parameters associated with the request. The user interaction module 162 may access other sources of data (e.g., clinical studies associated with medication regimens, medical research, etc.) from one or more memory devices and/or databases associated with the service provider system 106.

At block 306, the application tier 104 determines whether the requested medical information is available via the EMR module 160 and/or the user interaction module 162. If at block 306, the application tier 104 determines that the requested medical information is available, the YES branch is followed and processing may proceed to block 308. If however, at block 306 the application tier 104 determines that the requested information is not available, the NO branch is followed and processing may proceed to block 312.

At block 308, the requested medical information may be communicated to the interface module 140 of application tier 104. At block 310, the requested medical information is output for communication to the client device 102. The method 300 may end after block 310.

At block 312, a notification may be communicated to a user informing the user that the requested medical information is not available. At block 314, a request for medical information including new query parameters may be communicated. At block 316, an interface module 140 may determine whether a request for medical information including new query parameters has been communicated by the client device 102. If at block 316, the interface module 140 of the application tier 104 determines a request for medical information including new query parameters has been communicated, then the YES branch is followed and processing may proceed to block 304. If however, at block 316, the interface module 140 of the application tier 104 determines that a request for medical information including new query parameters has not been communicated, then the NO branch is followed and the process may end.

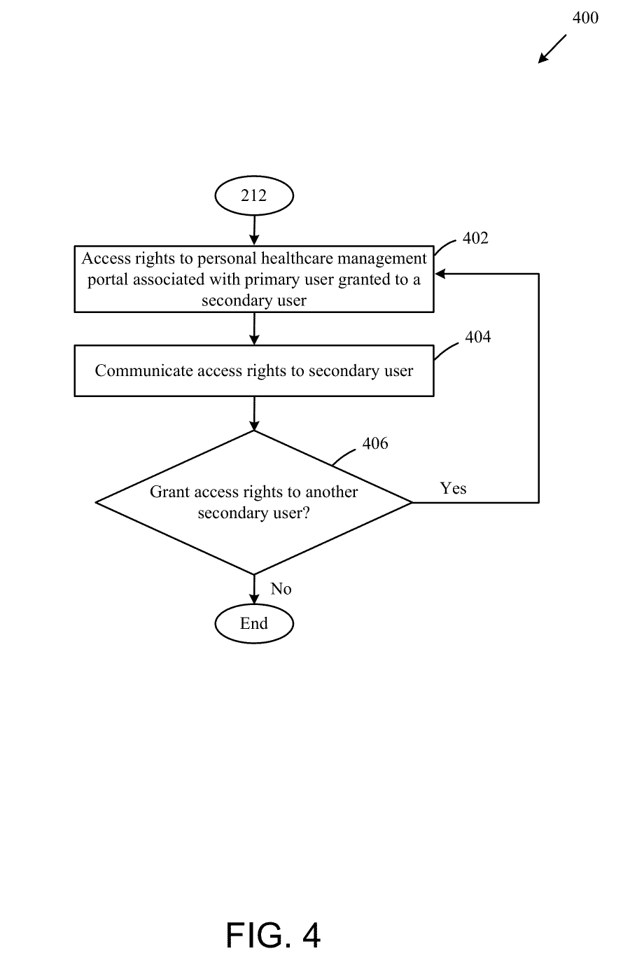

FIG. 4 illustrates a flow chart of an example method 400 for delegating, to a secondary user, access and/or authority to a primary user's healthcare information and/or records, according to one exemplary embodiment. As described herein at least with respect to FIG. 2, a user, such as a primary user, may be granted secure access to a personal healthcare management portal and a communication session may be established with application tier 104. Referring now to FIGS. 1 and 4, the exemplary method 400 begins at block 402, where the primary user may grant access rights to a personal healthcare management portal, such as management portal 124, to one or more secondary users. In one non-limiting example, the access rights are established by the primary user and associated with the primary user's account. The access rights may permit the secondary user to access the primary user's medical records as well as other associated patient information. For example, a secondary user designated as a proxy user may be granted permission to access and/or interact with the personal healthcare management portal in a similar manner as the primary user. In another non-limiting example, a secondary user may only have permission to access and/or interact with generally available information (e.g., clinical studies, etc.), but does not have access access to information designated as “off limits”. For example, the primary user may have a history of mental illness. The primary user may not want a caregiver, such as a hired caregiver, to have access to such private information and therefore may not grant access to the “off limits” designated information.

At block 404, a secondary user's access rights to a management portal associated with a primary user may be communicated to the secondary user. In one non-limiting example, interface module 140 of the application tier 104 may communicate the access rights to the secondary user via the network 108. The access rights may be communicated, without limitation, by text, electronic mail, social media, direct messaging, or any other available communication medium. The communication may include, without limitation, instructions informing the secondary user how to access the personal healthcare management portal associated with the primary user. For example, the instructions may include, without limitation, secondary user authentication information specific to the secondary user. The secondary user authentication information may be validated in a manner similar to that described herein at least with respect to FIG. 2.

At block 406, the primary user may decide to grant another set of secondary user's access rights to another secondary user. If at block 406, the primary user decides to grant another set of secondary user's access rights, the YES branch is followed and processing may proceed to block 402. If however, at block 406 the user decides not to grant another set of secondary user's access rights, the NO branch is followed and the method may end.

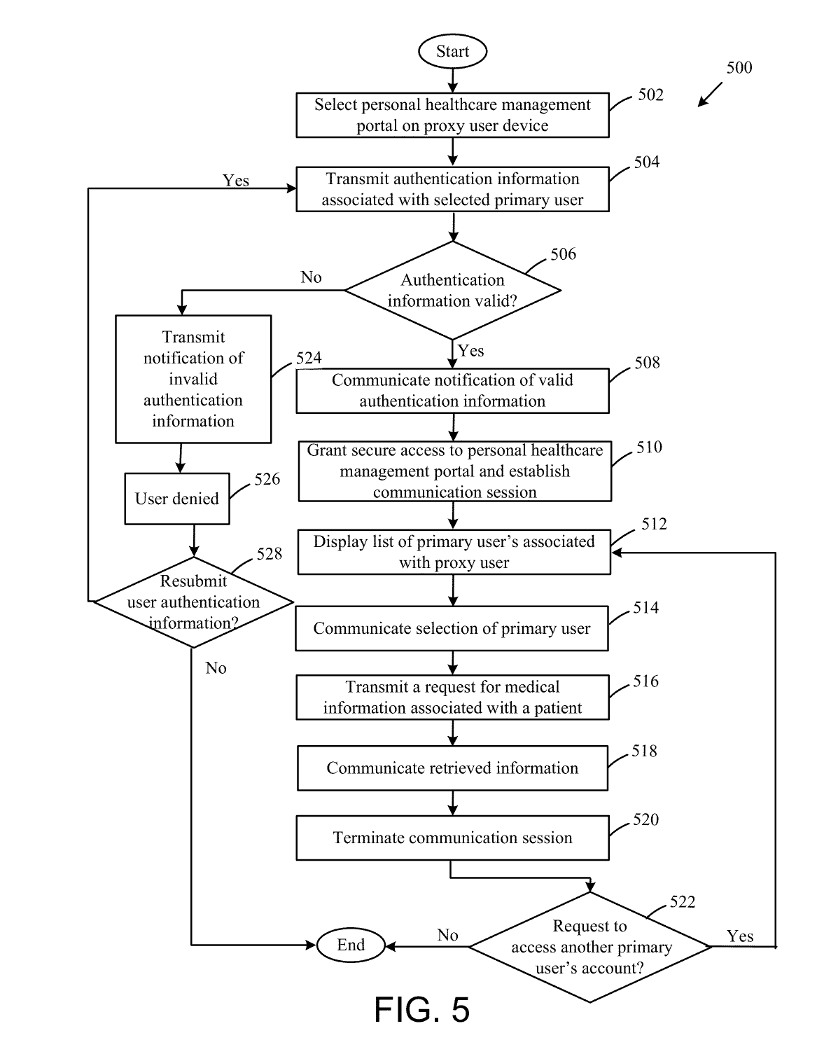

FIG. 5 illustrates a flow chart of an example method 500 for providing a proxy user access to a primary user's healthcare information and/or records, according to one exemplary embodiment. Now referring to FIGS. 1 and 5, the exemplary method 500 begins at block 502, where a personal healthcare management portal may be selected from a proxy user device, such as the management portal 124 of the client device 102. In one non-limiting example, the personal healthcare management portal may provide a proxy user secure access to a primary user's healthcare information.

At block 504, authentication information may be transmitted to an interface module of an application tier for evaluation, such as the interface module 140 of the application tier 104. At block 506, the application tier 104 determines whether the authentication information is valid. In one non-limiting example, the interface module 140 of application tier 104 may determine that the authentication information is valid by comparing the authentication information to one or more corresponding primary user records stored in the database 142 and/or 164. If, at block 506, the application tier 104 determines that the authentication information matches the primary user records existing in a primary user file, then the YES branch is followed and processing may proceed to block 508. However, if at block 506, the application tier 104 determines that the authentication information does not match user records existing in a user file, then the NO branch is followed and processing may proceed to block 524.

At block 508, notification of validated user authentication information may be transmitted from the application tier 104 to the client device 102. At block 510, the proxy user may be granted secure access to a personal healthcare management portal and a communication session may be established. In certain embodiments, the communication session may be a web-based communications session. As another example, a communication session may be established via a dedicated network, such as a dedicated healthcare network.

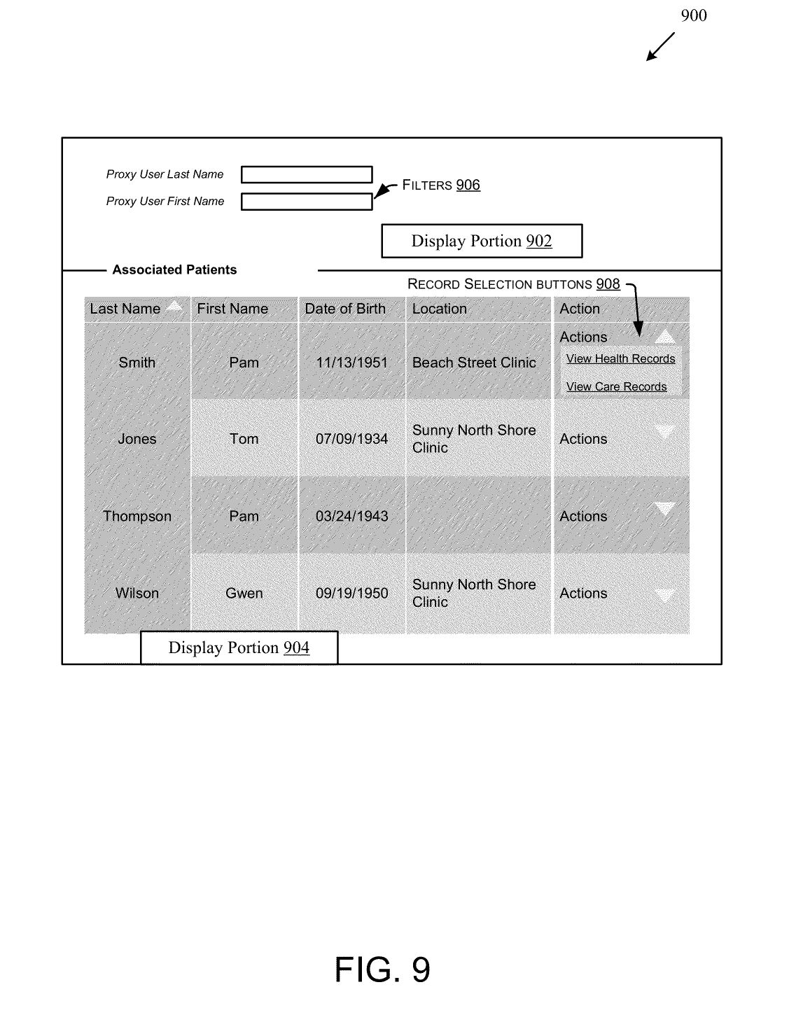

At block 512, a list of primary user's accessible to a proxy user may be displayed to the proxy user on a proxy user device, such as client device 102. In one non-limiting example, interface module 140 may access the list of accessible primary user's associated with the proxy user and prepopulate a primary user selection list to present to the proxy user, similar to the interface described herein at least with regards to FIG. 9.

At block 514, a primary user selection is communicated to the application tier 104 by the proxy user device. At block 516, a request for information associated with the primary user may be received at an interface module, such as interface module 140 of application tier 104. The request may be limited by the level of access granted to the proxy user. For example, if the proxy user is granted full access similar to the primary user, the proxy user may request any healthcare information also accessible to the primary user through the management portal 124. However, if the access rights are limited, the proxy user may only request information associated with the limited access rights.

At block 518, the requested information may be communicated to the client device 102 in a manner similar to that described herein at least with respect to FIG. 3. At block 520, the proxy user may terminate the communication session associated with a primary user by logging out of the management portal 124. At block 522, an interface module 140 may determine whether access to another primary user's account has been requested by the proxy user. If, at block 522, the proxy user has requested secure access to another primary user's account, the YES branch is followed and processing may proceed to block 512. If at block 522, the proxy user does not request secure access to another primary user's account, then the NO branch is followed and the method may end.

At block 524 notification of invalid proxy user authentication information may be transmitted from the application tier 104 to the client device 102. At block 526, a proxy user may be denied secure access to a primary user's personal healthcare management portal, such as management portal 124. At block 528, the interface module may determine whether a proxy user has attempted to resubmit user authentication information to access the primary user account. If at block 528, the interface module determines that a proxy user has resubmitted authentication information, the YES branch is followed and processing may proceed to block 504. If however, at block 528, the proxy user fails to resubmit authentication information, the NO branch is followed and the method may end.

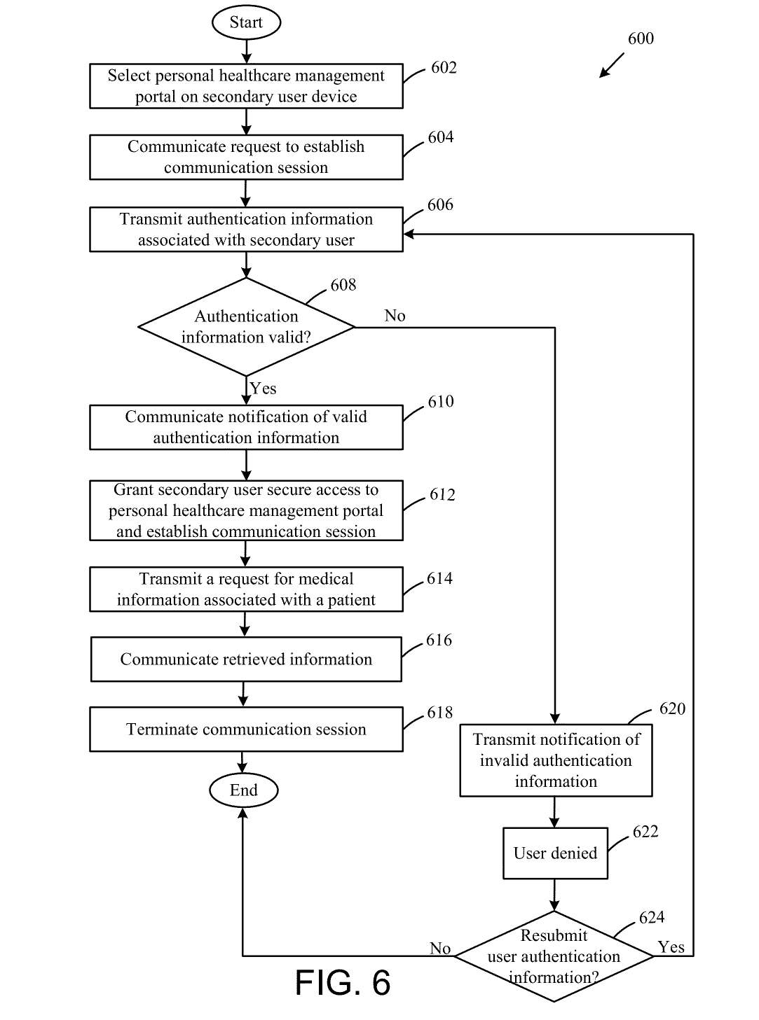

FIG. 6 illustrates a flow chart of an example method 600 for providing a secondary user access to a primary user's healthcare information and/or records, according to one exemplary embodiment. Referring now to FIGS. 1 and 6, the exemplary method 600 begins at block 602, where a personal healthcare management portal may be selected from a secondary user device, such as the management portal 124 of the client device 102. In one non-limiting example, the personal healthcare management portal may provide a secondary user secure access to a primary user's healthcare information. For example, without limitation, a secondary user may include a caregiver associated with the primary user (e.g., a home care nurse), a supportive caregiver associated with the primary user (e.g., a relative, a friend, etc.), or the like.

At block 604, a request to establish a communication session with a client device 102 may be communicated to an interface module, such as interface module 140 of the application tier 104. In one non-limiting example, the request may include a request to authenticate the secondary user prior to establishing the communication session. For example, the secondary user may be prompted to input login credentials associated with management portal 124 previously communicated to them by the primary user. The login credentials and/or other authentication information may include, without limitation, a username/password, a digital certificate, an encryption key, etc.

At block 606, authentication information may be transmitted to an interface module of an application tier 104 for evaluation, such as the interface module 140. At block 608, the application tier 104 determines whether the authentication information is valid. In one non-limiting example, the interface module 140 of the application tier 104 may determine that the authentication information is valid by comparing the authentication information to one or more corresponding primary user records stored in database 142 and/or 164. If, at block 608, the application tier 104 determines that the authentication information matches the primary user records existing in a primary user file, then the YES branch is followed and processing may proceed to block 610. However, if at block 608, the application tier 104 determines that the authentication information does not match user records existing in a user file, then the NO branch is followed and processing may proceed to block 620.

At block 610, notification of validated user authentication information may be transmitted from the application tier 104 to the client device 102. At block 612, the secondary user may be granted secure access to a primary user's personal healthcare management portal and a communication session may be established. In certain embodiments, the communication session may be a web-based communications session. As another example, a communication session may be established via a dedicated network, such as a dedicated healthcare network.

At block 614, a request for information associated with the primary user may be received at an interface module, such as the interface module 140 of the application tier 104. The request may be limited by the level of access granted to the secondary user. For example, if the secondary user is granted minimal access, the secondary user may only request information associated with the limited access rights accessible through management portal 124. For example, without limitation, a supportive caregiver may only have been granted access to information associated with the primary user's patient records (e.g., related clinical studies, medical research, and the like).

At block 616, the requested information may be communicated to the client device 102 in a manner similar to that described herein at least with respect to FIG. 3. At block 618, the secondary user may terminate the communication session associated with a primary user by logging out of the management portal 124. Method 600 may end after block 618.

At block 620 notification of invalid secondary user authentication information may be transmitted from the application tier 104 to the client device 102. At block 622, a secondary user may be denied secure access to a primary user's personal healthcare management portal, such as the management portal 124. At block 624, the interface module 140 may determine whether a secondary user has attempted to resubmit user authentication information to access the primary user's account. If at block 624, the interface module 140 determines that a secondary user has resubmitted authentication information, the YES branch is followed and processing may proceed to block 606. If however, at block 624, the secondary user fails to resubmit authentication information, the NO branch is followed and the method may end.

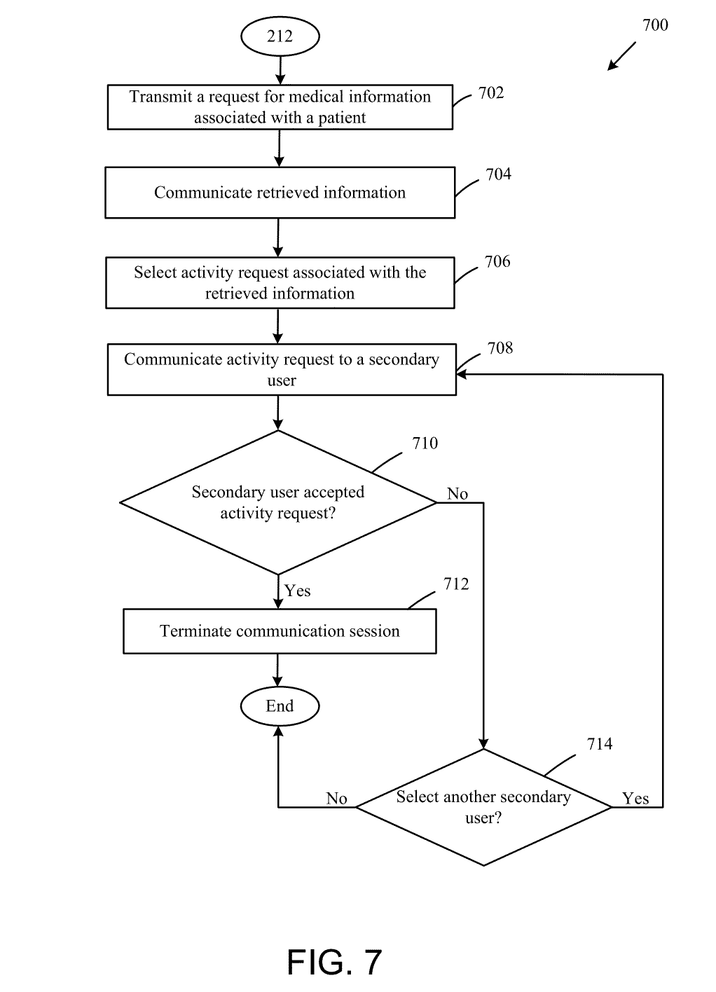

FIG. 7 illustrates a flow chart of an example method 700 for delivering a notification to a secondary user associated with a personal healthcare management portal, according to one exemplary embodiment. As described herein at least with respect to FIG. 2, a primary user may be granted secure access to a personal healthcare management portal and a communication session may be established with one or more service provider systems 106. Now referring to FIGS. 1 and 7, the exemplary method 700 begins at block 702, where a request for medical information associated with a primary user may be communicated by a client device 102. In one non-limiting example, the requested information associated with a primary user includes a dynamic record, for example, a real time appointment calendar associated with the primary patient. The request may include, without limitation, a query parameter associated with a specific time period (e.g., 10 days, 30 days, 60 days, etc.), days of the week, etc. In this example, the real time appointment calendar is populated with data associated with the primary patient including, without limitation, appointment dates, appointment times, appointment locations, appointment attendees, etc. The real time appointment calendar may include data from multiple sources (e.g., physicians) and may be accessible by secondary users, should appropriate authority be granted by the primary user.

At block 704, the interface module 140 may receive the request for medical information associated with a primary patient from the client device 102. The interface module 140 may subsequently query the service provider system 102 for the information requested by the client device 102 and present the data to the user in a manner similar to that described herein at least with respect to FIG. 3.

At block 706, an activity request for one or more supportive resources associated with the received medical information may be selected by the primary user on a client device 102. For example, without limitation, the medical information received by the client device 102 may include, without limitation, a real time appointment calendar similar to that described at block 702. Upon review of the real time appointment calendar, the primary user may determine that they do not have transportation to a schedule appointment. The primary user may access records associated with the primary user's account to select a secondary user, such as a supportive caregiver, caregiver, and/or any other individuals or organizations designated by the primary user as available to provide assistance. The primary user may select a secondary user and designate an associated activity request. For example, without limitation, an associated activity request may include a request for transportation to a scheduled medical appointment, a request for picking up a medication refill, a request for assistance during a medical appointment, a request to assist the patient with submission of a requested medical form prior to a scheduled appointment, etc.

At block 708, an activity request may be communicated to a secondary user by the interface module 140. In one non-limiting example, the activity request may be communicated to the secondary user by text, electronic mail, social media, direct messaging, or any other available communication medium. At block 710, the interface module 140 may determine whether the secondary user has accepted the activity request. If at block 710, the interface module determines that the secondary user has accepted the activity request, the YES branch is followed and processing may proceed to block 712. However, if at block 710 the interface module 140 determines that the secondary user has rejected the activity request, the NO branch is followed and processing may proceed to block 714. At block 712, the primary user may terminate the communication session by logging out of the management portal 124. The method may end after block 712.

At block 714, the interface module 140 may determine whether the primary user has selected another secondary user to communicate the activity request to. If at block 714, the interface module determines that another secondary user has been selected, the YES branch is followed and processing may proceed to block 708. However, if at block 714 the interface module 140 determines that another secondary user has not been selected, the NO branch is followed and the method may end.

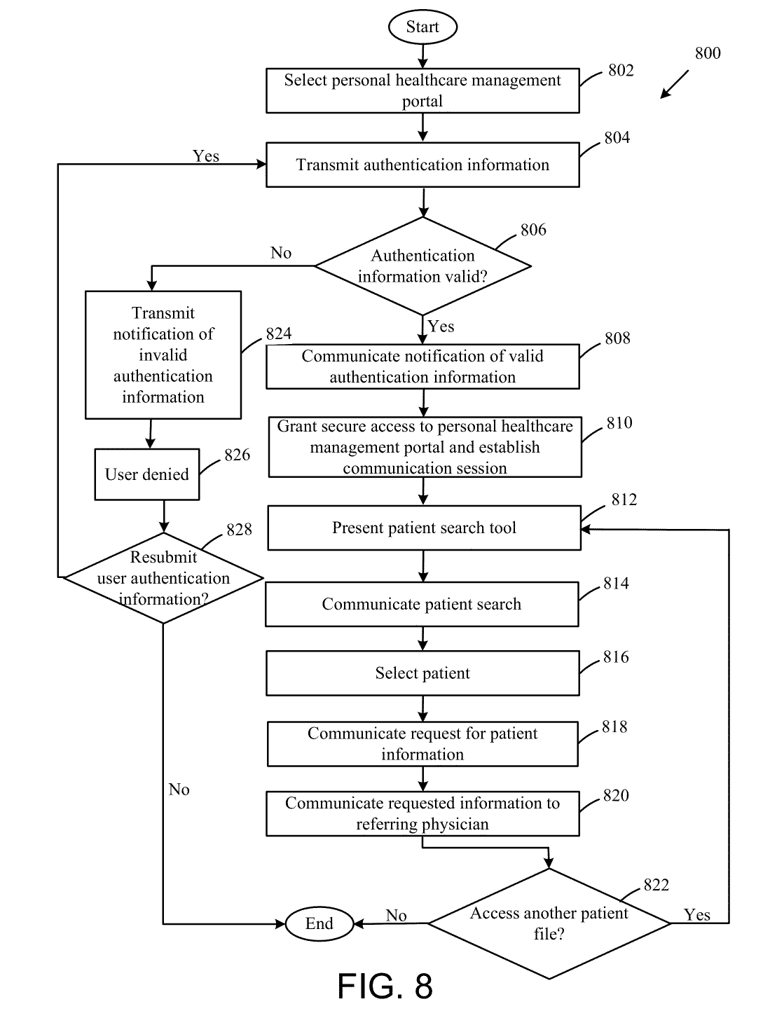

FIG. 8 illustrates a flow chart of an example method 800 for providing a referring physician access to a patient's healthcare information and/or records, according to one exemplary embodiment. Referring now to FIGS. 1 and 8, the exemplary method 800 begins at block 802, where a request to access a management portal 124 may be received by an interface module, such as an interface module 140 of an application tier 104. The request may be submitted by a healthcare provider such as, without limitation, a referring physician (e.g., a primary care physician associated with a patient) or a staff member acting on behalf of the referring physician (e.g., a nurse, a records supervisor, clerical staff, etc.). In one non-limiting example, the request may include input login credentials associated with the management portal 124 previously provided to the referring physician. The one or more login credentials and/or other authentication information may include, without limitation, a username/password, a digital certificate, an encryption key, etc.

At block 804, authentication information may be transmitted to an interface module 140 of an application tier 104 for evaluation. At block 806, the application tier 104 determines whether the authentication information is valid. If, at block 806, the application tier 104 determines that the authentication information input by the referring physician is valid, then the YES branch is followed and processing may proceed to block 808. However, if at block 806, the application tier 104 determines that authentication information input by the referring physician is not valid, then the NO branch is followed and processing may proceed to block 824.

At block 808, notification of validated user authentication information may be transmitted from the application tier 104 to a referring physician device. At block 810, the referring physician may be granted secure access to a personal healthcare management portal and a communication session may be established. In certain example embodiments, the communication session may be a web-based communications session. As another example, a communication session may be established via a dedicated network, such as a dedicated healthcare network.

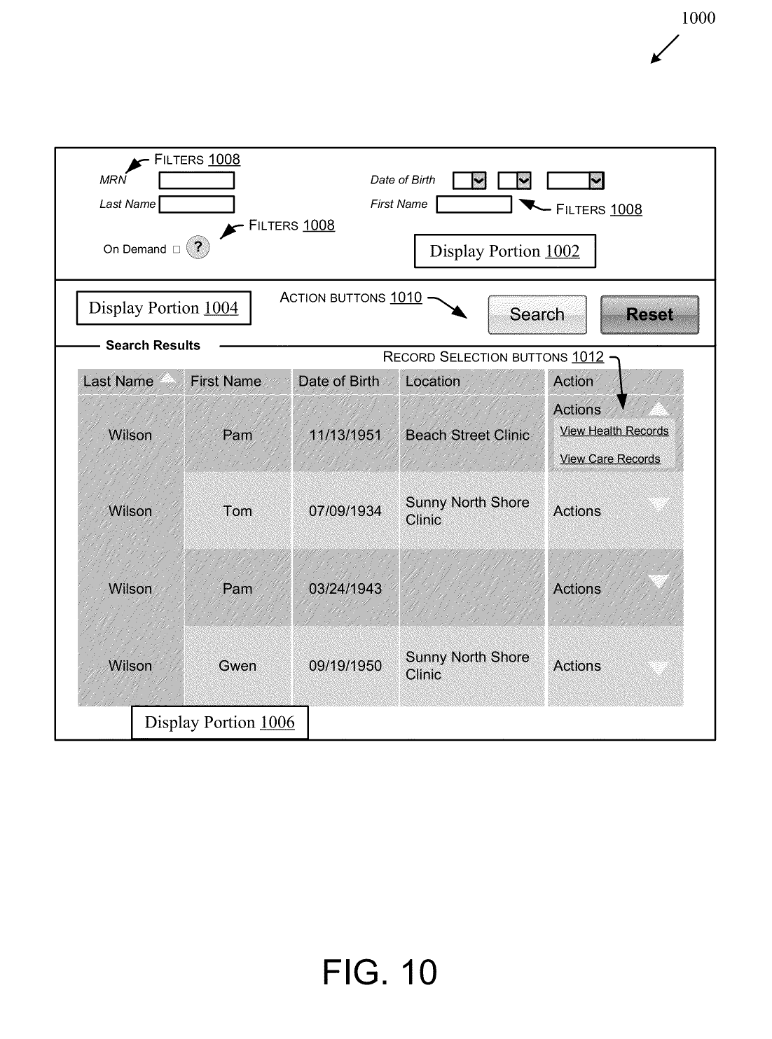

At block 812, a patient search tool may be presented to a referring physician on a referring physician device, such as the client device 102. For example, without limitation, interface module 140 may access and present the search tool to the referring physician on the referring physician device 102. In one non-limiting example, the search tool presented may be similar to the interface described herein at least with regards to FIG. 10. At block 814, the referring physician conducts a patient search. In one non-limiting example, the search may be conducted based upon search parameters including, without limitation, a patient's first name, a patient's last name, a patient's first and last name, a patient's medical record number (MRN), a patient's birthdate, a patient's social security number, a patient's email address, a patient's phone number, etc.

At block 816, the referring physician may select the appropriate patient if more than one patient has presented as a result of the patient search. At block 818, a request for information associated with the selected patient may be received at the interface module 140. The request may include information associated with patient's care in a specialty setting. The information requested may include, without limitation, medications prescribed, lab results, treatment outcomes, etc.

At block 820, the requested information may be communicated to the client device 102 in a manner similar to that described herein at least with respect to FIG. 3. At block 822, the interface module 140 may determine whether access to another patient file has been requested by the referring physician. If, at block 822, the referring physician has requested secure access to another patient file, the YES branch is followed and processing may proceed to block 812. If at block 822, the referring physician has not requested secure access to another patient file, then the NO branch is followed and the method may end.

At block 824, notification of invalid referring physician authentication information may be transmitted to the client device 102. At block 826, the referring physician may be denied secure access to the personal healthcare management portal, such as the management portal 124. At block 828, the interface module 140 may determine whether the referring physician has attempted to resubmit user authentication information to access the management portal 124. If, at block 828, the interface module determines that the referring physician has resubmitted authentication information, the YES branch is followed and processing may proceed to block 804. If however, at block 828, the referring physician fails to resubmit authentication information, the NO branch is followed and the method may end.

Various block and/or flow diagrams of systems, methods, apparatus, and/or computer program products according to example embodiments of the disclosure are described above. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments.

These computer-executable program instructions may be loaded onto a special-purpose computer or other particular machine, one or more processors, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, various embodiments of the disclosure may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Many modifications and other embodiments of the disclosure set forth herein will be apparent having the benefit of the teachings presented in the foregoing descriptions and the associated drawings. Therefore, it is to be understood that the claims are not to be limited to the specific embodiments disclosed and that modifications and other embodiments are intended to be included within the scope of the appended claims. Although specific terms are employed herein, they are used in a generic and descriptive sense only and not for purposes of limitation.

Illustrative Graphical User Interfaces

FIGS. 9 and 10 depict example graphical user interfaces that may be displayed in accordance with various embodiments of the disclosure. In certain embodiments, the example system of FIG. 1 and the example processes of FIGS. 2-8 may be implemented with the example user interfaces. The graphical user interface may, for example, facilitate secure access to patient healthcare information.

Turning first to FIG. 9, a first example graphical user interface 900 is depicted. In one non-limiting example, the interface 900 may illustrate a graphical display presented by a personal healthcare management portal to a proxy user. It is to be understood, that the filtering functionality represented in FIG. 9 is a presentation of possible filtering functionality and is not intended to be an exhaustive representation. In some instances, the interface 900 may include, without limitation, one or more possible display portions 902 and 904. The display portion 902 may include one or more filters 906. In one non-limiting example, the filtering functionality may include a last name, first name, and/or other selections. The display portion 904 may include one or more record selection buttons 908. In one non-limiting example, the record selection buttons may include the ability to view a health record, a care record, and/or other selections.

At FIG. 10, another example graphical user interface 1000 is depicted. In one non-limiting example, the interface 1000 may illustrate a graphical display presented by a personal healthcare management portal to a referring physician. It is to be understood, that the filtering functionality represented in FIG. 10 is a presentation of possible filtering functionality and is not intended to be an exhaustive representation. In some instances, the interface 1000 may include, without limitation, one or more possible display portions 1002, 1004, and 1006. The display portion 1002 may also include one or more filters 1008. In one non-limiting example, the filtering functionality may include a medical record number (MRN), last name, first name, birthdate, and/or other selections. The display portion 1004 may include one or more action buttons 1010. In one non-limiting example, the action buttons may include a search button, a reset button, and/or other selections. The display portion 1006 may include results of the an executed search with one or more record selection buttons 1012. In one non-limiting example, the record selection buttons may include the ability to view a health record, a care record, and/or other selections.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments.

That which is claimed:

1. A computer-implemented method, comprising:
receiving, from a client device, a selection of a patient healthcare management portal associated;
receiving authentication information associated with the selection of the patient healthcare management portal;
determining if the authentication information is associated with a user's valid login credentials;
receiving a request to access patient information, wherein the patient information includes at least one of a one or more records, one or more forms, or one or more services associated with the patient;
retrieving, based on a positive determination that the authentication information is associated with the user's valid login credentials, the requested patient information; and
communicating the requested information to the client device,
wherein the above operations are performed by one or more computers associated with an application tier.

2. The method of claim 1, wherein the authentication information is associated with a designated user, the designated user including at least one of a primary user, a proxy user, a secondary user, or a physician.

3. The method of claim 1 further comprising the steps of:
determining, based at least in part on the authentication information, a level of access associated with a user requesting access to the patient healthcare management portal; and
restricting access to patient information accessible via the patient healthcare management portal based at least in part on the determined level of access associated with the user.

4. The method of claim 1 further comprising the steps of:
determining, based at least in part on the authentication information, that a user requesting access to the patient healthcare management portal is a proxy user;
displaying a list of one or more accessible primary users associated with the authentication information; and
receiving a selection of a primary user from the list of one or more accessible primary users.

5. The method of claim 4 further comprising the steps of:
receiving a request to access information of a second patient, wherein the information of the second patient includes at least one of one or more records, one or more forms, or one or more services associated with the second patient;
retrieving the requested information for the second patient; and
communicating the requested information to the client device.

6. The method of claim 1, wherein the user's login credentials include at least one of a username and password, a digital certificate, or an encryption key.

7. The method of claim 6, further comprising the step of transmitting a notification of an activity request to a secondary user, wherein the activity request is associated with a patient scheduled appointment and includes at least one of a transportation request, a request to accompany the patient to the scheduled appointment, or a request to assist the patient with submission of medical information to one or more physicians prior to the scheduled appointment.

8. The method of claim 1, wherein retrieving the requested patient information includes retrieving the patient information from at least one of an electronic medical record (EMR) associated with the patient or one or more data files, the one or more data files including at least one of a clinical study, medical research, or general medical information.

9. The method of claim 1, further comprising the steps of:
determining, based at least in part on one or more patient search parameters, one or more patients accessible to the user; and
selecting a desired patient from the one or more patients accessible to the user.

10. The method of claim 9, wherein the search parameters include at least one of a patient's name, a patient's birthdate, or a medical record number.

11. A system comprising:
at least one memory operable to store computer-executable instructions; and
at least one processor configured to access the at least one memory and execute the computer-executable instructions to:
receive, from a client device, a selection of a patient healthcare management portal associated with a patient;
receive authentication information associated with the selection of the patient healthcare management portal associated with the patient;
determine if the authentication information is associated with a users valid login credentials;
receive a request to access patient information, wherein the patient information includes at least one of a one or more records, one or more forms, or one or more services associated with the patient;
retrieve, based on a positive determination that the authentication information is associated with the user's valid login credentials, the requested patient information; and
direct communication of the requested information to the client device.

12. The system of claim 11, wherein the authentication information is associated with a designated user, the designated user including at least one of a primary user, a proxy user, a secondary, or a physician.

13. The system of claim 11, wherein the at least one processor is further configured to access the at least one memory and execute the computer-executable instructions to:
determine, based at least in part on the authentication information, a level of access associated with a user requesting access to the patient healthcare management portal; and
restrict access to patient information accessible via the patient healthcare management portal based, at least in part, on the determined level of access associated with the user.

14. The system of claim 11, wherein the at least one processor is further configured to access the at least one memory and execute the computer-executable instructions to:
determine, based at least in part on the authentication information, that a user requesting access to the patient healthcare management portal is a proxy user; and
permit the proxy user unlimited access to the patient information associated with patient healthcare management portal.

15. The system of claim 14, wherein the at least one processor is further configured to access the at least one memory and execute the computer-executable instructions to:
receive a request to access information of a second patient, wherein the information of the second patient includes at least one of one or more records, one or more forms, or one or more services associated with the second patient;
retrieve the requested information for the second patient; and
direct the communication of the requested information to the client device.

16. The system of claim 11, wherein the user's login credentials include at least one of a username and password, a digital certificate, or an encryption key.

17. The system of claim 11, wherein the at least one processor is further configured to access the at least one memory and execute the computer-executable instructions to direct communication of a notification of an activity request to a secondary user, wherein the activity request is associated with a patient scheduled appointment and includes at least one of a transportation request, a request to accompany the patient to the scheduled appointment, or a request to assist the patient with submission of medical information to one or more physicians prior to the scheduled appointment.

18. The system of claim 11, wherein the at least one processor is further configured to access the at least one memory and execute the computer-executable instructions to retrieve the patient information from at least one of an electronic medical record (EMR) associated with the patient or one or more data files, the one or more data files including at least one of a clinical study, medical research, or general medical information.

19. The system of claim 11, wherein the at least one processor is further configured to:
determine, based at least in part on one or more patient search parameters, one or more patients accessible to the user; and
select a desired patient from the one or more patients accessible to the user

20. The system of claim 19, wherein the search parameters include at least one of a patient's name, a patient's birthdate, or a medical record number.
